(19) United States
(12) Patent Application Publication
(10) Pub. No.: US 2025/0142360 A1
(43) Pub. Date: May 1, 2025

(54) USER EQUIPMENT, ACCESS NETWORK NODE, AND A METHOD PERFORMED BY THEM

(71) Applicant: NEC Corporation, Minato-ku, Tokyo (JP)

(72) Inventors: Tingyu XIN, Tokyo (JP); Yuhua CHEN, London (GB); Hisashi FUTAKI, Tokyo (JP)

(73) Assignee: NEC Corporation, Minato-ku, Tokyo (JP)

(21) Appl. No.: 18/835,447

(22) PCT Filed: Mar. 6, 2023
(86) PCT No.: PCT/JP2023/008250

§ 371 Date: Aug. 2, 2024

(30) Foreign Application Priority Data
Mar. 18, 2022 (GB) 2203837.6

(51) Int. Cl. H04W 24/02; H04W 36/08; H04W 56/00; H04W 76/20; H04W 84/06

(52) U.S. Cl. CPC H04W 24/02; H04W 36/08; H04W 56/0045; H04W 76/20; H04W 84/06

(57) ABSTRACT

The present disclosure relates to user equipment, access network node, and a method performed by them. A method performed by a user equipment (UE) for communicating via a non-terrestrial network is disclosed. The method comprises receive configuration information identifying preconfigured uplink resources for use by the UE in a Radio Resource Control (RRC) idle state; verify whether or not the configuration information is still valid; and determine whether to transmit data using the preconfigured uplink resources in accordance with the verifying.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to communications using preconfigured resources in the so-called ‘Next Generation’ (‘5G’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. End-user communication devices are commonly referred to as User Equipment (UE) which may be operated by a human or comprise automated devices. Such mobile (or even generally stationary) devices are typically operated by a user (and hence they are often collectively referred to as user equipment, ‘UE’) although it is also possible to connect so-called Internet-of-Things (IoT) devices and similar Machine-Type Communication (MTC) devices to the network. For simplicity, the present application will use the term base station to refer to any such base stations and use the term mobile device or UE to refer to any such communication device.

The latest developments of the 3GPP standards cover an evolving communication technology that is expected to support a variety of applications and services such as MTC, IoT/Industrial IoT (IIoT) communications, vehicular communications and autonomous cars, high resolution video streaming, smart city services, and/or the like.

In order to provide enhanced support for MTC devices, 3GPP introduced the ‘eMTC’ (enhanced MTC) UE category in Release 12, and specified the first low-complexity UE category 0 (Cat-0). Cat-0 supports a reduced peak data rate of 1 Mbps, a single antenna and half duplex frequency division duplex (HD FDD) operation. 3GPP Release 13 introduced support for the so-called ‘Cat-M1’ UEs which allows additional cost reduction due to a reduced transmission and reception bandwidth of 1.08 MHz, the introduction of a lower UE power class of 20 dBm in addition to the 23 dBm power class. Cat-M1 UEs operate in a narrowband (NB) and they may also support coverage enhanced (CE) operation. In LTE Releases 14 and 15, a new UE category Cat-M2 was specified with 5 MHz transmission and reception bandwidth.

In Release 13 3GPP started to work on Narrowband Internet-of-Things (NB-IoT) UE with the total baseband bandwidth of 180 kHz. NB-IoT supports operation on an anchor carrier (where the UE assumes certain signal and channels being transmitted) and on a non-anchor carrier (where such signal and channels are not assumed to be transmitted). Similarly to eMTC, NB-IoT makes use of increased acquisition times and time repetitions to extend the system coverage. However, unlike MTC, NB-IoT does not support measurement reporting and handover in connected mode.

3GPP is also working on specifying an integrated satellite and terrestrial network infrastructure. For example, 3GPP Technical Report (TR) 36.763 V17.0.0 is a study on Narrow-Band Internet of Things (NB-IoT)/enhanced Machine Type Communication (eMTC) support for Non-Terrestrial Networks in Release 17. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP TR 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.1.0 provides further details about NTN.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterised by beam(s) covering the same geographical areas all the time (e.g. GEO satellites and HAPS);
quasi-Earth-fixed cells characterised by beam(s) covering one geographic area for a finite period and a different geographic area during another period (e.g. NGEO satellites generating steerable beams); and
Earth-moving cells characterised by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit.

Non-Geosynchronous Orbit (NGSO) satellites are a type of NGEO satellites (e.g. LEO or MEO satellites) which are characterised by an Earth-centred orbit with an orbital period that does not match Earth's rotation on its axis. This means that there is a relative movement between an NGSO satellite and Earth resulting in a coverage area of the satellite (cell) that may vary with time.

As described in 3GPP TR 36.763, 3GPP's current approach is that existing cellular IoT features specified up to Release 16 (such as support of 4G/5G core network, Early Data Transmission (EDT), Preconfigured Uplink Resources (PUR), Self-Organising Network (SON) functionality, etc.) can be enabled in NTN deployments unless they require major change for adaptation to NTN.

Turning now to the specific case of PUR, this feature is intended for Radio Resource Control (RRC) idle state UEs, which can use their associated (valid) PUR configuration to perform uplink transmissions without performing time and energy consuming procedures (e.g. random access) to obtain uplink grants. The network can configure appropriate PUR resources for a UE when the RRC connection of the UE is released. Then, whilst in the idle mode, if the UE has uplink data to send, it validates whether a PUR resource can be used in the current cell and transmits data using the preconfigured resource. When validating whether a suitable PUR resource is available, the UE checks whether it has a valid timing advance/timing alignment (which may be determined using an associated timer) and whether the variation of signal level (given by an associated Reference Signal Received Power, or ‘RSRP’) in the cell exceeds the configured thresholds.

However, the inventors have realised that the current standards define procedures which have been developed with terrestrial networks in mind and these procedures may not be directly applicable to non-terrestrial networks.

For example, in case of NGSO cells (cells served via NGSO satellites) and similar cells with non-continuous coverage, the timing advance/timing alignment May become invalid and/or the signal variation threshold may be exceeded relatively quickly due to movement of the satellites on their orbit even though the same cell (or another cell) may become available again in a predictable manner (e.g. following a regular pattern or any other pattern that is known in advance). Thus, usability of PUR in some systems involving a non-terrestrial portion may be severely limited and may result in an increase of power consumption at the UE and an increased network load. For IoT or eMTC devices it is very important that they are able to reduce the time spent on uplink transmission procedures, and to reduce power consumption which may increase the lifetime of such devices.

### SUMMARY OF INVENTION

### Solution to Problem

Accordingly, there is a need to provide an improved procedure for preconfiguring uplink resources for user equipment using (e.g. camping on) cells served by non-terrestrial nodes such as satellites or UAS. The present disclosure seeks to provide methods and associated apparatus that address or at least alleviate (at least some of) the above described issues.

Although for efficiency of understanding for those of skill in the art, the disclosure will be described in detail in the context of a 3GPP system (LTE/5G networks including NTN), the principles of the disclosure can be applied to other systems as well.

In one aspect, the disclosure provides a method performed by a user equipment (UE) for communicating via a non-terrestrial network, the method comprising: receiving configuration information identifying preconfigured uplink resources for use by the UE in a Radio Resource Control (RRC) idle state; verifying whether or not the configuration information is still valid; and determining whether to transmit data using the preconfigured uplink resources in accordance with the verifying.

In one aspect, the disclosure provides a method performed by an access network node for communicating with a user equipment (UE) via a non-terrestrial network, the method comprising: transmitting configuration information identifying preconfigured uplink resources for use by the UE in a Radio Resource Control (RRC) idle state; and transmitting receiving information indicating whether the configuration information is valid, and wherein the information is used by the UE for verifying whether or not the configuration information is still valid.

In one aspect, the disclosure provides a user equipment (UE) for communicating via a non-terrestrial network, the UE comprising: means for receiving configuration information identifying preconfigured uplink resources for use by the UE in a Radio Resource Control (RRC) idle state; means for verifying whether or not the configuration information is still valid; and means for determining whether to transmit data using the preconfigured uplink resources in accordance with the verifying.

In one aspect, the disclosure provides an access network node for communicating with a user equipment (UE) via a non-terrestrial network, the access network node comprising: means for transmitting configuration information identifying preconfigured uplink resources for use by the UE in a Radio Resource Control (RRC) idle state; and means for transmitting receiving information indicating whether the configuration information is valid, and wherein the information is used by the UE for verifying whether or not the configuration information is still valid.

### Advantageous Effects of Invention

Aspects of the disclosure extend to corresponding systems and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1;

FIG. 3 is a schematic block diagram of an access network node (e.g. base station) or an NTN node (e.g. satellite/UAS platform) forming part of the system shown in FIG. 1;

FIG. 4 is a schematic block diagram of a core network node (e.g. MME) forming part of the system shown in FIG. 1;

FIG. 5 illustrate schematically some exemplary ways in which the present disclosure may be implemented in the system shown in FIG. 1;

FIG. 6 is illustrate schematically some exemplary ways in which the present disclosure may be implemented in the system shown in FIG. 1;

FIG. 7 illustrate schematically some exemplary ways in which the present disclosure may be implemented in the system shown in FIG. 1;

FIG. 8 illustrate schematically some exemplary ways in which the present disclosure may be implemented in the system shown in FIG. 1;

FIG. 9 illustrate schematically some exemplary ways in which the present disclosure may be implemented in the system shown in FIG. 1;

FIG. 10 illustrate schematically some exemplary ways in which the present disclosure may be implemented in the system shown in FIG. 1;

FIG. 11 illustrate schematically some exemplary ways in which the present disclosure may be implemented in the system shown in FIG. 1;

FIG. 12 illustrate schematically some exemplary ways in which the present disclosure may be implemented in the system shown in FIG. 1;

FIG. 13 illustrate schematically some exemplary ways in which the present disclosure may be implemented in the system shown in FIG. 1; and

FIG. 14 illustrates schematically some exemplary architecture options for the provision of NTN features in the system shown in FIG. 1.

### DESCRIPTION OF EMBODIMENTS

### Overview

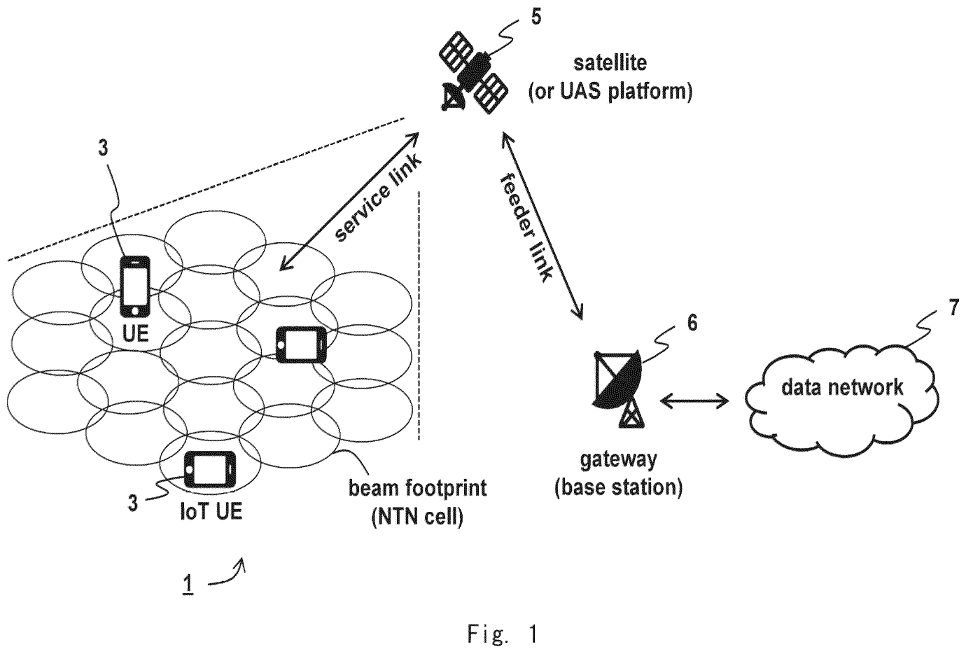

FIG. 1 illustrates schematically a mobile (cellular or wireless) telecommunication system 1 to which embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA (4G) and/or NR (5G) RAT. In case of an E-UTRA RAT, the base station 6 may be referred to as an ‘eNB’ or ‘ng-eNB’ and in case of an NR RAT, the base station 6 may be referred to as a ‘gNB’. The UEs 3 may comprise NB-IoT or MTC UEs or they may include appropriate NB-IoT or MTC functionality. As those skilled in the art will appreciate, whilst three UEs 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface, and/or the like). The base stations 6 are also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). Typically, the data network 7 will include user plane entities and control plane entities. The so-called Mobility Management Entity (MME) in 4G, or the Access and Mobility Management Function (AMF) in 5G, is responsible for handling connection and mobility management tasks for the mobile devices 3, including configuring any power saving mechanisms. The data network 7 is also coupled to other data networks such as the Internet or similar Internet Protocol (IP) based networks (not shown in FIG. 1).

Each NTN node 5 controls a number of directional beams (at least one beam) via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

The network also supports communications for UEs 3 in idle state using preconfigured uplink resources (PUR). Specifically, PUR may be configured for a compatible UE 3 when the base station 6 releases the RRC connection of that UE 3. Details of the applicable PUR configuration are included in a message for releasing the UE's connection (e.g. an RRCConnectionRelease message) or a message for RRC reconfiguration (e.g. an RRCReconfiguration/RRCConnectionReconfiguration message). The PUR configuration (at least a part of it) is included in one or more suitable information element of the message.

With PUR configured, the UE in idle state is allowed to transmit data over the PUR resource thereby reducing the need for additional signalling related to scheduling the UE's transmission, which is also beneficial from the perspective of the UE's power consumption. However, before transmitting using PUR, the UE 3 verifies whether the resource can be used, i.e. whether or not the relevant PUR configuration is still valid.

In more detail, in a terrestrial network, before transmission using PUR, the UE 3 checks whether the associated timing advance or timing alignment value is still valid (i.e. the so-called pur-TimeAlignmentTimer is not expired, if configured) and checks whether the reference signal received power variation for the current cell has not exceeded the configured thresholds (if applicable).

It will be appreciated that in the non-terrestrial portion of the network 1 satellite coverage might be non-continuous, especially for IoT devices deployed in remote areas. This means that when the UE 3 is out of coverage or when the UE 3 selects a new serving cell, the timing alignment is no longer valid.

The present disclosure discusses various ways (or solutions) in which the UE 3 can be configured to use the PUR configured by a given cell in other cells, even in cells that have non-continuous coverage (such as certain NTN cells).

In a first solution, the PUR configuration is associated with a plurality of cells (identified by e.g. a cell list) and the UE 3 is configured to continue to use the PUR configuration across multiple cells.

In a second solution, the UE 3 is configured to use its PUR configuration from a previous cell in a new serving cell that is determined to be identical or to be a replacement cell to the previous cell. A cell may be determined to be identical to another cell based on their carrier frequencies, cell identifiers, system information, and/or any other cell parameter. In this case, it is not necessary to provide a cell list to the UE 3 because the UE 3 may have other ways to determine whether or not the PUR configuration can be used in the new cell.

In a third solution, the PUR is valid while the UE 3 is covered by satellites (regardless of which cell). In this case the network transmits to the UE 3 information relating to a coverage provided via the associated cells (coverage start-times, end-times, etc.) so that the UE 3 can determine the window(s) of coverage during which the PUR can be used.

In a fourth solution, the PUR may be valid within a configured area. The area may be determined based on a reference location and a threshold and/or based on any other information (beam footprint size and/or the like) from which the UE 3 can determine an area served by the satellite 6.

In a fifth solution, validity of the PUR configuration may be controlled by changing the way the UE 3 handles an associated timer whilst served by the non-terrestrial portion of the network.

Beneficially, these solutions allow the UE 3 to apply appropriate PUR configuration across a plurality of cells and transmit uplink data in a fast an efficient manner.

### <User Equipment (UE)>

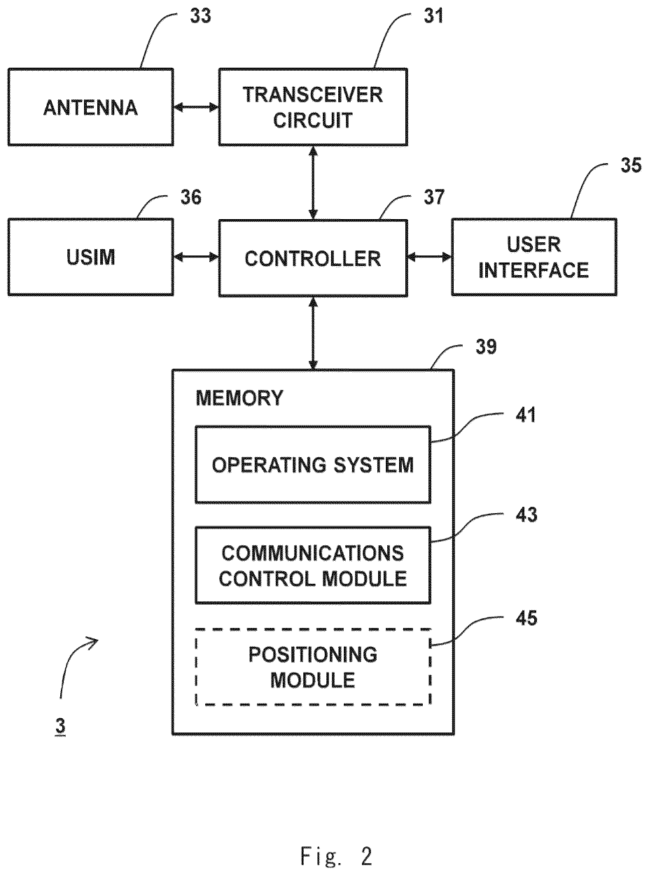

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35 and one or more Universal Subscriber Identity Module (USIM) 36) which may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a positioning module 45 (which is optional in some UEs).

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling related to communications using preconfigured uplink resources (via non-terrestrial networks). When the UE 3 is configured to operate in eMTC/IoT/NB-IoT/IoT-NTN mode, the operation of the communications control module 43 is adapted accordingly.

If present, the positioning module 45 is responsible for determining the position of the UE 3, for example based on Global Navigation Satellite System (GNSS) signals.

### <Access Network Node (Base Station/Gateway) and NTN Node>

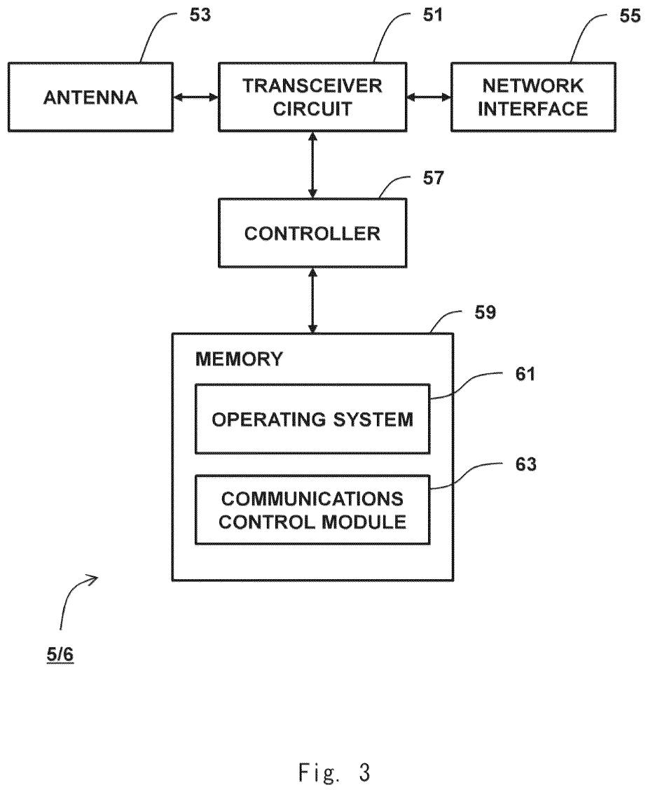

FIG. 3 is a block diagram illustrating the main components of an access network node 6 (such as the base station (gNB) or the gateway) shown in FIG. 1. FIG. 3 is also applicable to the NTN node 5 (satellite or UAS platform). As shown, the access network node 6/NTN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. Signals may be transmitted to and received from the UE(s) 3 either directly and/or via one or more NTN node(s) 5, as appropriate. The network interface 55 typically includes an appropriate base station-base station interface (such as X2/Xn) and an appropriate base station-core network interface (such as S1/NG-C/NG-U), although some of these may be optional in case of the NTN node 5. A controller 57 controls the operation of the access network node 6/NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the access network node 6/NTN node 5 and other nodes, such as the UE 3, other NTN nodes 5/base stations 6, and core network nodes (e.g. the MME 9). The signalling may comprise control signalling related to communications using preconfigured uplink resources (via non-terrestrial networks).

### <Core Network Node>

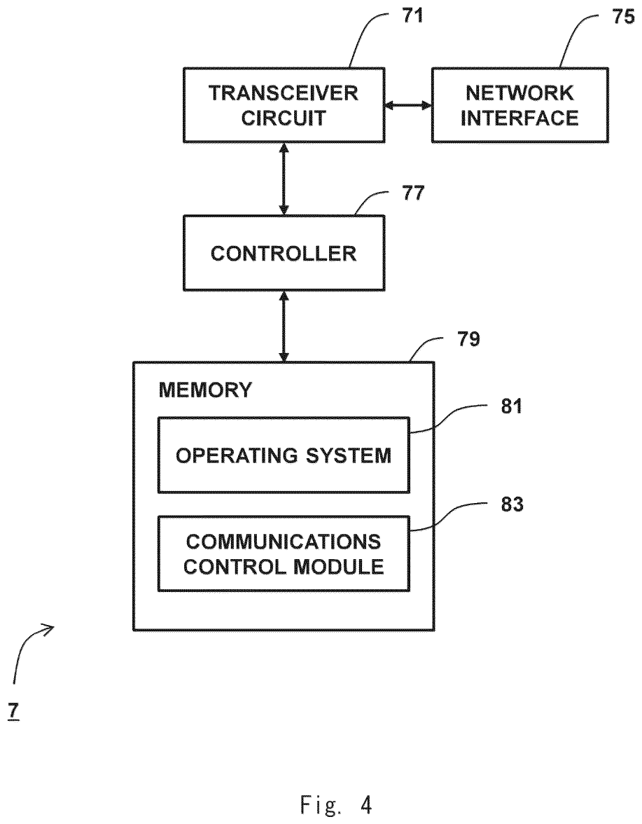

FIG. 4 is a block diagram illustrating the main components of a core network node shown in FIG. 1. As shown, the core network node includes a transceiver circuit 71 which is operable to transmit signals to and to receive signals from other network nodes (either directly or indirectly) via a network interface 75. The network interface 75 typically includes an appropriate core network-base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the core network node and the UE 3, the access network nodes, and other core network nodes. The signalling may comprise control signalling related to communications using preconfigured uplink resources (via non-terrestrial networks).

### Detailed Description

The following is a description of some exemplary procedures (referred to as Solutions 1 to 5) performed by the nodes of the system shown in FIG. 1 for communicating using preconfigured uplink resources.

However, before discussing the details of these procedures in the context of non-terrestrial networks, we provide an overview of timing alignment validation for communications using PUR in terrestrial networks, in accordance with 3GPP TS 36.331, section 5.3.3.19:

The UE shall consider the timing alignment value for transmission using PUR to be valid when the following conditions are fulfilled:
1> either pur-TimeAlignmentTimer is not configured or pur-TimeAlignmentTimer is running as confirmed by lower layers; and
1> either pur-RSRP-ChangeThreshold (pur-NRSRP-ChangeThreshold in NB-IoT) is not configured or the following conditions are fulfilled:
2> compared to the stored serving cell reference (N) RSRP value, the serving cell (N) RSRP has not increased by more than increaseThresh; and
2> compared to the stored serving cell reference (N) RSRP value, the serving cell (N) RSRP has not decreased by more than decreaseThresh.

Accordingly, in a terrestrial network, before a transmission using PUR, the UE 3 shall check that it has a valid timing alignment (or timing advance) value (i.e. an associated pur-TimeAlignmentTimer is either not configured or it has not expired) and verify that the reference signal received power variation for the current cell has not exceeded the configured thresholds in either direction (if such thresholds have been configured).

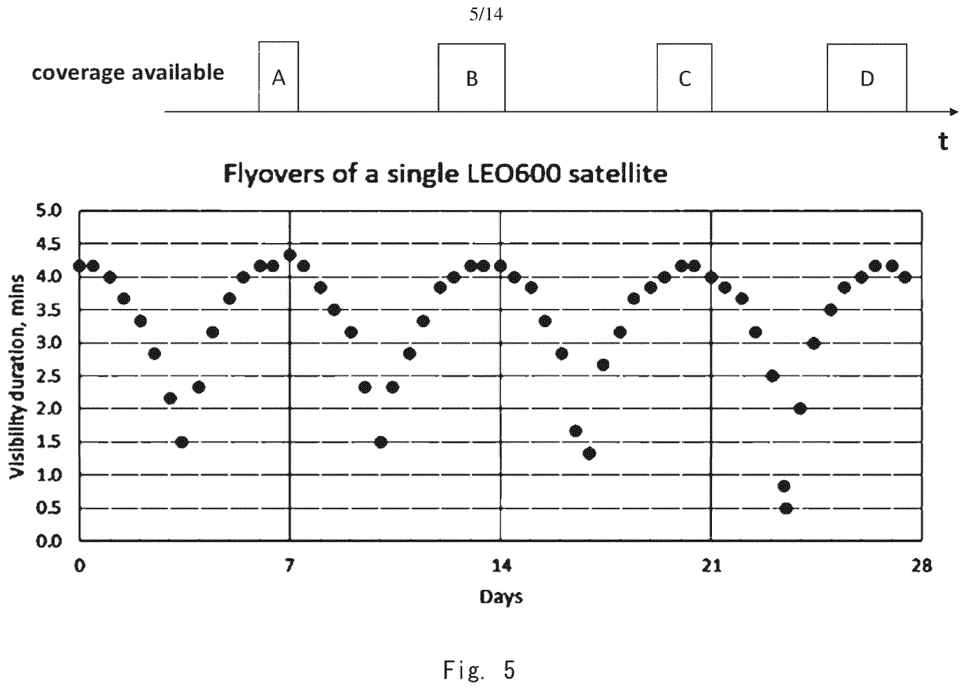

Turning now to the non-terrestrial portion of the network 1, it will be appreciated that satellite coverage might be non-continuous, especially for IoT devices deployed in remote areas. When a UE 3 (IoT device) is served by a satellite 5, the cell coverage lasts for Δt within a period of T, and the value of both Δt and T may vary. For example, if the UE 3 is served by a single satellite (LEO at 600 km altitude), the interval T may vary between 9 and 13.3 hours, and the coverage time Δt may vary from 1 to 4 minutes. In the example shown in FIG. 5, satellite coverage will be available in the windows denoted A, B, C, and D (each representing a respective period T). The windows may have different durations and may be spaced apart unevenly. In some areas, no satellite coverage may be available at all (e.g. if there are no satellites deployed to serve that area and/or that particular UE 3). This means that after the applicable coverage time Δt (or after movement of the UE 3 into an area where no coverage is available) the reference signal received power variation for the UE 3 will exceed the configured thresholds causing the timing alignment to be no longer valid for that cell. Furthermore, the fast relative movement between the UE 3 and the satellite 6 also leads to significant reference signal received power variation, which causes the timing alignment to be no longer valid for that cell.

However, there are benefits of using PUR even for NGSO-based cells, especially for IoT devices and similar UEs 3. The median flyover lasts around 220 s, and 90% of flyovers are longer than 110 s. Link budgets are weaker at lower elevation angles. Therefore, the UE 3 needs to complete its uplink transmissions within the limited coverage time. This may be problematic, and increase signalling related power consumption as well, using normal (grant based) scheduling methods. By using PUR, the UE 3 can use a valid PUR to perform uplink transmissions in RRC idle state without performing random access procedures to obtain uplink grants. By reducing the time spent on uplink transmission procedures, UE power consumption and network workload may also be reduced. Since power consumption is a critical issue for IoT devices, any reduction in power consumption may increase the lifetime of these devices.

The present disclosure discusses various ways in which the UE 3 can be configured to use the PUR configured by a given cell in other cells, even in cells that have non-continuous coverage (NTN cells) that lasts for a relatively short time, as opposed to the cell specific PUR currently proposed in the 3GPP specifications (Release 16).

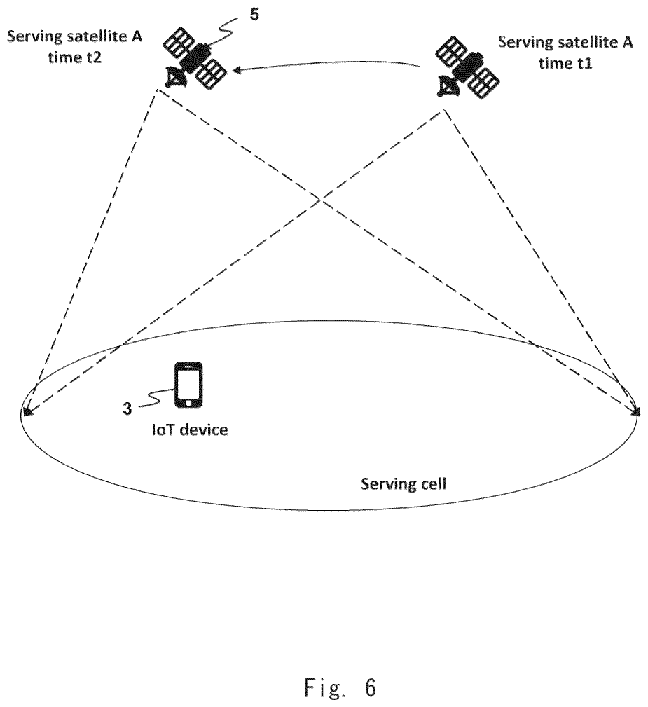

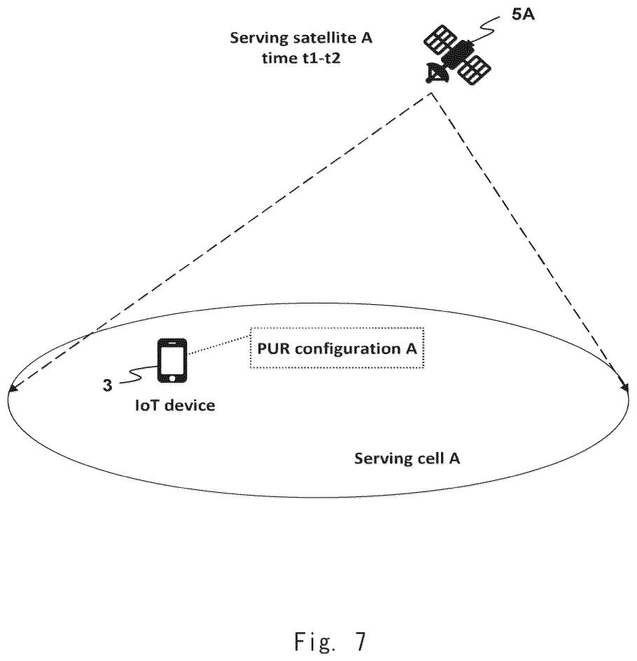

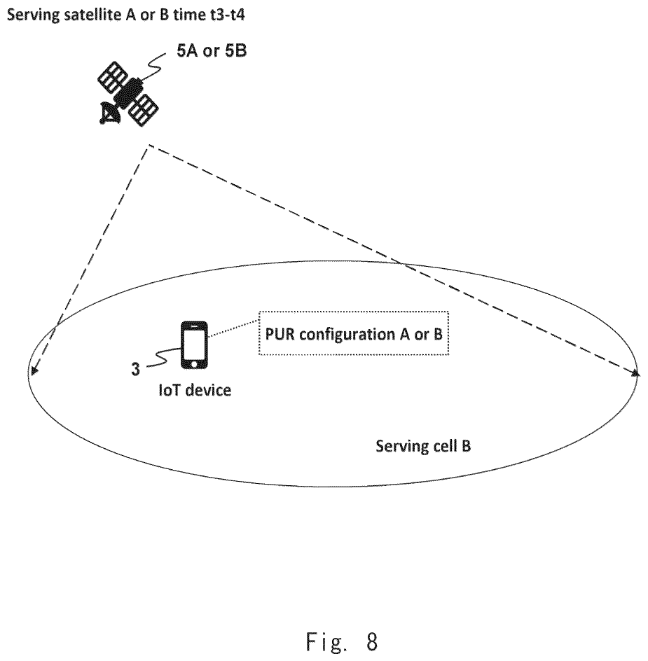

FIG. 6 illustrates schematically an exemplary scenario in which a satellite 5 covers a UE 3 between time t1 and time t2 via an associated serving cell. Effectively, the coverage time Δt for the cell is given by t2 minus t1. FIG. 7 is effectively the same scenario as shown in FIG. 6. In this case a first satellite 5A covers the UE 3 between time t1 and time t2 via its cell A for which the UE 3 may be configured with an associated PUR configuration A (upon release or reconfiguration of the associated RRC connection). The UE 3 (e.g. an IoT device) may not have frequent uplink data. Thus, it may not use the PUR configured by cell A in cell A. Turning now to FIG. 8, the same satellite 5A (or a different satellite 5B) covers the UE 3 between time t3 and time t4 via cell B for which the UE 3 may either continue to apply the PUR configuration A or apply a new PUR configuration B and transmit uplink data accordingly. For a particular area, such as a geographical area, the network may configure the ‘same’ resources for the cells covering that area at different times. Therefore, the PUR/PUR configuration can be reused across cells. Beneficially, by continuing to use its old PUR configuration in a new cell, or by adapting the old PUR configuration to the new cell, the UE 3 is able to save power.

### <Solution 1>

In this solution, the PUR configuration is associated with a plurality of cells (identified by e.g. a cell list).

For example, an information element for configuring PUR (‘pur-Config’ and/or the like) or any other suitable information element may be used to identify one or more cells (NTN cells) for which the PUR configuration may be applied by the UE 3. It will be appreciated that the information element may be included in an appropriately formatted RRCConnectionRelease message or similar. The RRCConnectionRelease message is used in 3GPP systems to command the release of an RRC connection (direction: network to UE). Some relevant details of the RRCConnectionRelease message are shown below, including a ‘pur-Config-r16’ information element (for Release 16) for setting up or releasing a PUR configuration:

```
-- ASN1START
[...]
RRCConnectionRelease-v1610-IEs ::=SEQUENCE {
  [...]
  puc-Config-r16SetupRelease {PUR-Config-r16} OPTIONAL,
  -- Need ON
  [...]
```

It will be appreciated that an appropriately formatted RRC reconfiguration message may be used to similar effect.

In existing techniques, if the UE 3 changes the cell it camps on, the configured PUR becomes invalid and the UE 3 needs to perform a random access procedure before it can transmit any uplink data.

In NTN scenarios, due to the limited coverage time of each cell (e.g. in the NGSO scenario), the UE 3 may change cells due to the movement of the satellite, instead of UE mobility. The network may configure the same resources for the same area via different satellites 5 at different times. In this case, PUR configured in one cell may also be applicable in other cells in the same area.

In this example (referred to as ‘solution 1’) the base station 6 (using its communications control module 63) informs the UE 3 of the cells (in the form of a cell list and/or the like) where the configured PUR can be used. Thus, when performing uplink transmission, the UE 3 validates (using its communications control module 43) the PUR by checking whether the UE's current cell is included in the cell list. In this case the current cell refers to the cell on which the UE 3 is camping in idle state.

For example, the base station 6 may send the PUR configuration to the UE 3 via the above described RRC connection release or reconfiguration message. The cell list may be included within the ‘pur-Config’ information element (e.g. a Release 17 version) or any other suitable information element. The cell list may also be included in a different message, if appropriate, e.g. in system information block (SIB). At least some of the cells in the cell list might be replacement cells of the cell that configured the PUR, i.e. cells covering the same area at different times. The cell list may include the physical cell ID (PCI), Cell Global ID (CGI), carrier frequency, etc. of the cells (e.g. in one or more associated information element). In some cases, the cell list may include only one cell (at least initially, or after removal of one or more cell). A plurality of cells (or the cells list) may be provided by adding cells to an existing set of cells. The set of cells may comprise one cell (e.g. initially). The cells may be added one by one, or in groups. Removal of one or more cell from the cell list may be realised in a similar manner to cell addition. A replacement cell may cause removal from the cell list of the cell it replaces. Alternatively, the replacement cell may be added to the cell list.

In summary, the network (the base station 6) configures the UE 3 for communicating via the non-terrestrial network portion using preconfigured uplink resources. The network does so by transmitting appropriate configuration information identifying the preconfigured uplink resources for use by the UE 3 in RRC idle state and by also transmitting information identifying the cells (e.g. by a list of cells) where the configuration information is applicable. The configuration information may be transmitted to the UE 3 in an appropriately formatted message for releasing the RRC connection (such as the above described RRCConnectionRelease message) or an RRC reconfiguration message. The cell list may also be transmitted in the same message or using a different message (e.g. via a system information block).

The UE 3 stores the PUR configuration (in its memory 39) and applies it in any cell included in the cell list, as long as other associated conditions are met (if any). At one point, the UE 3 performs cell reselection and camps on a new cell. If the information of the new cell, i.e. PCI, GCI etc., are included in the cell list associated with the PUR configuration, the UE 3 considers that the configured PUR can be used in this new cell. For example, if the PUR was configured by cell A (FIG. 7), and cell B is included in the cell list, then the PUR can also be used in cell B (FIG. 8).

It will be appreciated that the base stations 6 may be configured to coordinate with each other to exchange (via the network interface 55) the information related to their PUR configuration and the associated cell list. The satellite(s) 5 that cover a certain area at different times may be served by different base stations 6, i.e. satellites A and B connect to base stations A and B, respectively. Alternatively, the same satellite 5 may connect to different base stations 6 (gateways) at different times, and it may serve the same are via different cells. The PUR configuration including the cell list is exchanged between base stations 6. Therefore, when generating a cell list the base stations 6 are able to configure proper resources to support the configured PUR in multiple cells.

### <Solution 2>

In this solution, the UE 3 is configured to use its PUR configuration from a previous cell in a new serving cell that is determined to be identical or to be a replacement cell to the previous cell. In this case, it is not necessary to provide a cell list to the UE 3 in advance because the UE 3 may be able to determine whether or not the PUR configuration can be used in the new cell.

Referring to FIGS. 7 and 8 again, for a certain area, the coverage of cell A and cell B may be provided by satellites A and B, respectively, at different times. Alternatively, the same satellite may serve cell A and cell B at different times. However, it will be appreciated that some resources and configurations might be the same for both cell A and cell B.

For example, cell B might be named as a replacement cell of cell A. In other words, the network (base station 6) may provide an explicit indication that cell B replaces cell A. In this case, the UE 3 can consider the two cells as being ‘identical’ cells, and continue to apply some of the configurations (in this case PUR) from cell A to cell B as well.

In order to determine whether the configuration provided by the previous serving cell can be used in the new cell, the following actions may be performed.

The base station 6 indicates whether the new serving cell (cell B) is ‘identical’/a replacement cell to the previous serving cell (cell A). In one option, the base station 6 indicates whether the new serving cell (cell B) is ‘identical’ to the previous serving cell (cell A) explicitly. The indication may be provided in various forms and using various means. For example, the base station 6 may indicate whether or not the cell could be considered as ‘identical’ to the previous serving cell (cell A), indicate whether or not the previously configured PUR can be used in the new cell (cell B), and/or the like.

In another option, the base station 6 indicates whether the new serving cell (cell B) is ‘identical’/a replacement cell to the previous serving cell (cell A) implicitly. For example, the base station may deploy the same carrier frequencies and the same cell parameters to cell A and cell B. The UE 3 stores the information of the previous serving cell A (e.g. carrier frequencies, PCI, Master Information Block (MIB), SIBs, etc.). In other words, the UE 3 keeps in its memory 39 the parameters associated with the cell where PUR was configured for the UE 3. The UE 3 may keep this information at least for a predetermined period or until the PUR is released by the network or until the UE 3 moves to an area where there is no replacement cell available. When the UE 3 starts camping on a new cell (cell B), the UE 3 monitors/acquires PSS, SSS, MIB, SIBs, etc, of cell B (served by satellite A or B).

If the UE determines whether cells A and B are the same (or equivalent) cell. If cell A and B are the ‘same’ cell, the PUR configured in cell A is still valid in cell B and can be used for uplink transmissions. For example, the UE 3 may be configured to consider two cells to be same/identical if one or more of the following parameters are identical: PCI, CGI, carrier frequency, bandwidth, system Info Value Tag, cell Identity, etc. For example, the system information (e.g. MIB) may include an appropriate indication that the system information remains unchanged (the value of the systemInfoUnchanged-BR field in MIB may be set to ‘TRUE’). In this case, it is not necessary to transmit the above mentioned parameters in the new cell, or the UE 3 does not need to acquire them in order to determine that the new cell is the same as the cell where the PUR was initially configured.

In summary, the network (base station 6) configures the UE 3 for communicating via the non-terrestrial network portion using preconfigured uplink resources. The network does so by transmitting appropriate configuration information identifying the preconfigured uplink resources for use by the UE 3, in its current cell, in RRC idle state (where the current cell may also be referred to as a first, or old cell). The configuration information may be transmitted to the UE 3 in an appropriately formatted message for releasing the RRC connection (e.g. an RRCConnectionRelease message) or an RRC reconfiguration message. The network (base station 6) also provides an appropriate indication (in an explicit or implicit manner) to allow the UE 3 to continue using its PUR configuration in a new serving cell (in substantially the same geographical area). If the UE 3 obtains such an explicit or implicit indication, e.g. via MIB/SIB, the UE 3 considers the PUR to be applicable in the new cell, based on this indication.

Beneficially, the UE 3 is able to determine whether to continue to apply the configuration information for a new (second) cell in a case that the new cell replaces the UE's old cell or in a case the new cell corresponds to the old cell (when the UE is out of coverage of the old cell). For example, the network/base station 6 may provide an appropriate indication (e.g. via a system information block) to inform the UE 3 that the new cell is identical to or corresponds to the old cell. Alternatively, the UE 3 may determine that the new cell is identical to or corresponds to the old cell based on implicit indication (by evaluating one or more cell specific parameter and determining that the relevant parameters are the same in both the old cell and the new cell).

### <Solution 3>

In this solution, the PUR is valid while the UE 3 is covered by satellites (regardless of which cell). It will be appreciated that solution 3 may be combined with solution 1 or 2 (at least some features thereof).

This solution relies on the following features which may be adapted for this purpose:
provision of information regarding the start-time of the (incoming) satellite's coverage and the end-time of the serving satellite's coverage (currently proposed for Quasi-Earth Fixed satellites such as LEO with steerable beam); and
satellite ephemeris parameters for predicting coverage discontinuity (in conjunction with any other relevant information such as beam information, elevation angle, reference location).

Beneficially, in discontinuous coverage cases (in non-terrestrial cells), the base station 6 informs the UE 3 of the relevant satellite information, and the UE 3 is allowed to use its configured PUR while satellite coverage is available. It will be appreciated that in such cases the UE 3 may be served by a single or a few satellite(s) 5. Due to the relative movement between the UE 3 and the satellite(s) 5 in NGSO scenarios, the coverage may be discontinuous (e.g. characterised by a period T and a coverage window Δt, as described above). If the UE 3 is out of coverage of any satellite, the UE 3 (e.g. an IoT device) may be configured to stay in this situation (i.e. not to attempt connecting to the network via a terrestrial cell), especially if the UE 3 does not have frequent data to send.

The base station 6 may send the UE 3 appropriate assistance information. For example, the assistance information may include satellite information (e.g. coverage start- and end-time, satellite ephemeris, etc.) and timing advance related parameters. It will be appreciated that instead ‘satellite information’, appropriate ‘non-terrestrial node information’ may be provided which may apply to other types of non-terrestrial nodes as well, such as HAPS, UAV, etc.

Using the received assistance information, the UE 3 is able to predict the coverage time of the satellite or cell and/or calculate the applicable timing advance value. It will be appreciated that the UE 3 may be configured to wake up only when coverage is available, thereby improving the UE's battery life/power consumption.

The UE 3 keeps the PUR configuration when it is out of coverage. Whenever the UE is back in coverage, it is allowed to use the configured PUR. The UE 3 may be able to use the configured PUR regardless of which non-terrestrial cell it camps on, unless the UE 3 is also configured with a list of cells where the PUR can be applied (e.g. as described in solution 1).

The satellite information (or non-terrestrial node information) may be associated with the PUR configuration. Different PUR configuration may be provided for different associated satellite information allowing the UE 3 to benefit from different configurations depending on which satellite (or which time window) is used by the UE 3. For example, a first set of time windows may be provided during off-peak times (via appropriate assistance information) together with a first PUR configuration, and a second set of time windows may be provided via appropriate assistance information together with a second PUR configuration (or without any PUR configuration) to control (or prevent) uplink transmissions in relatively busy periods. In discontinuous coverage cases, the UE 3 might be served by different satellites in turn. In this case, the UE 3 may be configured to use the PUR only if the coverage is provided by a satellite/some of the satellites or cell(s) associated with that PUR configuration (i.e. the PUR cannot be used if the coverage is provided by any other satellite or cell).

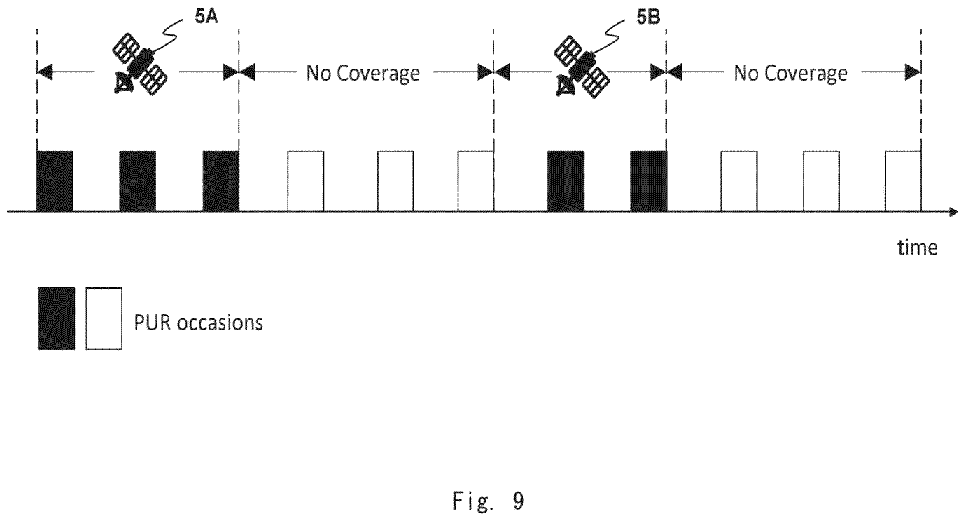

In legacy PUR configuration, there is an information element (pur-ImplicitReleaseAfter) that controls release of the PUR configuration. Specifically, based on this information element, the UE 3 releases its PUR configuration and/or considers the PUR configuration invalid if the UE 3 does not use the PUR occasions for a number of consecutive times given by the value of the information element. To avoid the UE 3 releasing the PUR configuration due to discontinuous coverage, in this system the PUR occasions are counted only when the UE 3 is in coverage (or in a pre-defined window). This approach is illustrated schematically in FIG. 9 where the black boxes represent PUR occasions while the UE 3 is in coverage (these occasions are considered when counting any missed PUR occasions) and the white boxes represent PUR occasions while the UE 3 is out of coverage (these occasions are not considered when counting any missed PUR occasions). The number of occasions counted by the UE 3 may be reset to ‘0’ when the UE 3 is out of coverage or upon re-entering coverage. Alternatively, the network configures the UE 3 to do not perform counting of missed PUR occasions in non-terrestrial cells (for example, by omitting the pur-ImplicitReleaseAfter information element from the relevant PUR configuration, or setting it to ‘0’, ‘max’, ‘off’, or any other suitable value indicating that counting is turned off).

In summary, the network (base station 6) configures the UE 3 for communicating via the non-terrestrial network portion using preconfigured uplink resources. The network does so by transmitting appropriate configuration information identifying the preconfigured uplink resources for use by the UE 3, in at least one non-terrestrial cell, in RRC idle state. The network also transmits information relating to a coverage provided via the at least one non-terrestrial cell (coverage start-time, end-time, etc.). The UE 3 applies the configuration information based on the information relating to the coverage.

### <Solution 4>

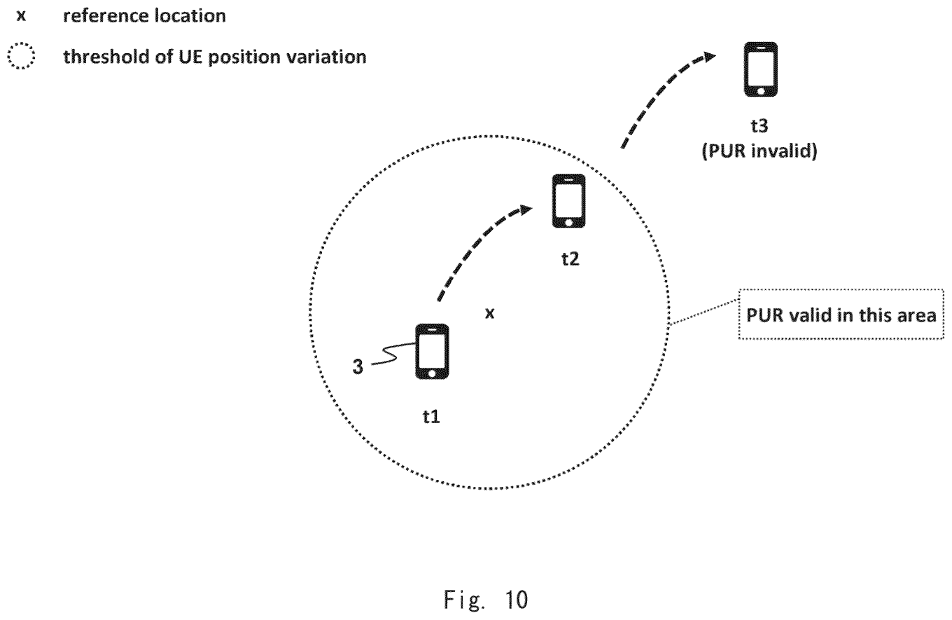

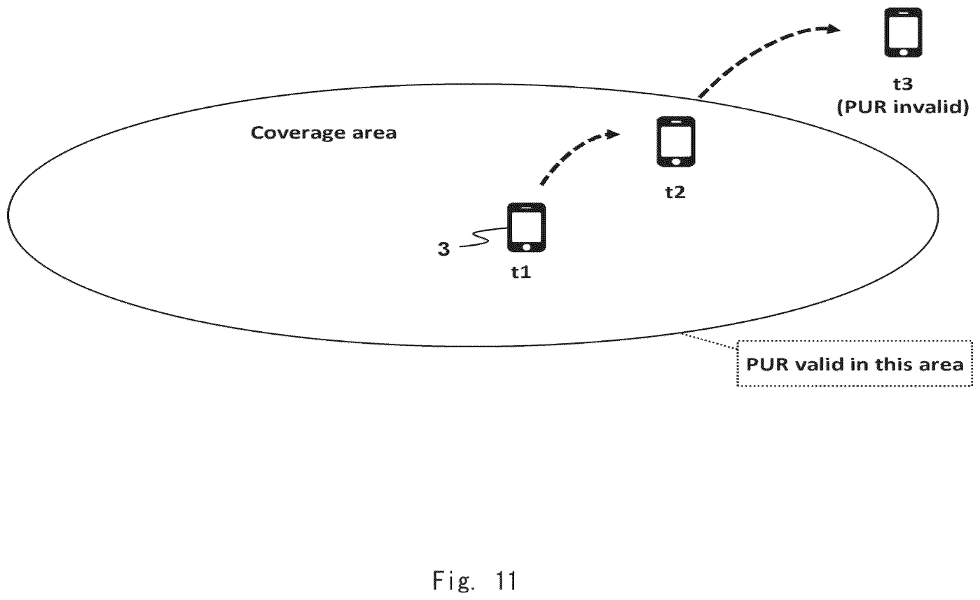

In this solution, the PUR is valid within a configured area, as illustrated schematically in FIGS. 10 and 11.

In accordance with existing techniques, a UE considers its PUR to be invalid when the variation of the reference signal received power exceeds the configured threshold (if configured). The variation may be indicative of location variation that may result in expiration of the timing alignment and cause radio link variation. However, in NTN scenarios, the variation of the reference signal received power may not be related to mobility of the UE 3 as it is more likely to be caused by movement of the satellite 5 serving the UE 3.

The UE 3 may have GNSS capability (or similar) and it may include an appropriate positioning module 45. Such UE 3 is normally aware of its geographical location and it can calculate the necessary timing alignment (timing advance) based on the satellite information and any timing alignment/timing advance related parameters provided by the network. Therefore, in non-terrestrial networks, there is no need to use RSRP thresholds to limit the position variation of the UE 3. It will be appreciated that some UEs, especially IoT UEs, may be able to obtain their GNSS location only in the RRC idle state or when there is no other operation due to their relatively simple components. Nevertheless, once obtained, the location information is valid for a duration before it needs to be obtained again.

FIG. 10 illustrates a first approach to limit the validity of PUR to an appropriate area. Effectively, when the UE 3 is within this (pre-configured or predetermined) area the PUR is valid, and when the UE 3 is outside of this area, the PUR is invalid. In this case, the base station 6 configures a threshold to limit the maximum allowed variation of the UE's position. The threshold may be applied to a suitable reference location, such as the UE's location when it released the RRC connection or the first subsequent location obtained in the RRC idle state. By comparing the UE's current location to the stored reference position, the UE 3 is able to determine the position variation (by calculating the distance from the current location to the reference location). If the variation exceeds the associated threshold, the timing alignment and/or the configured PUR will be considered to be invalid.

FIG. 11 illustrates a second approach to limit the validity of PUR to an appropriate area. In this case, the base station 6 indicates the UE 3 the cell coverage area associated with the PUR configuration either implicitly or explicitly. The base station 6 may indicate the cell coverage area by providing information regarding beam footprint size, geographical location of the cell centre, and/or the like, from which an area served by the satellite may be determined by the UE 3. In this case, the satellite position (if known from ephemeris data and/or the like) may be used as a reference point together with beam information to determine the area where the PUR is valid.

In summary, the network (base station 6) configures the UE 3 for communicating via the non-terrestrial network portion using preconfigured uplink resources. The network does so by transmitting appropriate configuration information identifying the preconfigured uplink resources for use by the UE 3, in at least one non-terrestrial cell, in RRC idle state. The configuration information may be transmitted to the UE 3 in an appropriately formatted message for releasing the RRC connection (e.g. an RRCConnectionRelease message) or an RRC reconfiguration message. The network (base station 6) also provides information for identifying an area where the configuration information is applicable to allow the UE 3 to continue using its PUR configuration in a new serving cell (in substantially the same geographical area).

### <Solution 5>

In this solution, the UE 3 is configured to determine whether its PUR configuration is valid by starting and stopping an associated timer (and ignoring the timer if appropriate). Effectively, the UE 3 is configured to handle the timer associated with PUR in a different manner depending on whether the UE 3 is served by a terrestrial cell or a non-terrestrial cell.

In a terrestrial network, before transmission using PUR, the UE 3 checks whether the associated timing advance value is still valid (i.e. the so-called pur-TimeAlignmentTimer is not expired) and checks whether the reference signal received power variation for the current cell has not exceeded the configured thresholds (if configured for the UE 3).

However, in a non-terrestrial network, such a timer may not be provided at all, or it may be disregarded by the UE 3. The UE 3 does not necessarily need to rely on a timer in a non-terrestrial network because the UE 3 may be able to determine the appropriate timing advance autonomously (from satellite information/ephemeris data, UE location, and other assistance information).

If a timer is configured for the non-terrestrial network portion as well, the UE 3 may be configured to not start (or to ignore) the timer if it uses non-terrestrial network services or it is camping on an non-terrestrial network cell. Even if the UE 3 does start the timer, expiration of the timer does not affect PUR validation for the non-terrestrial network.

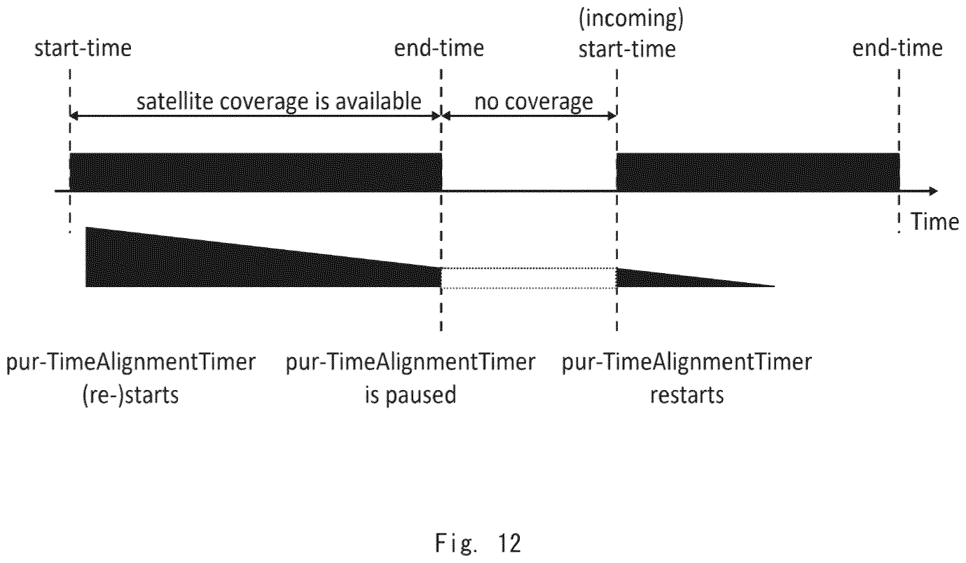

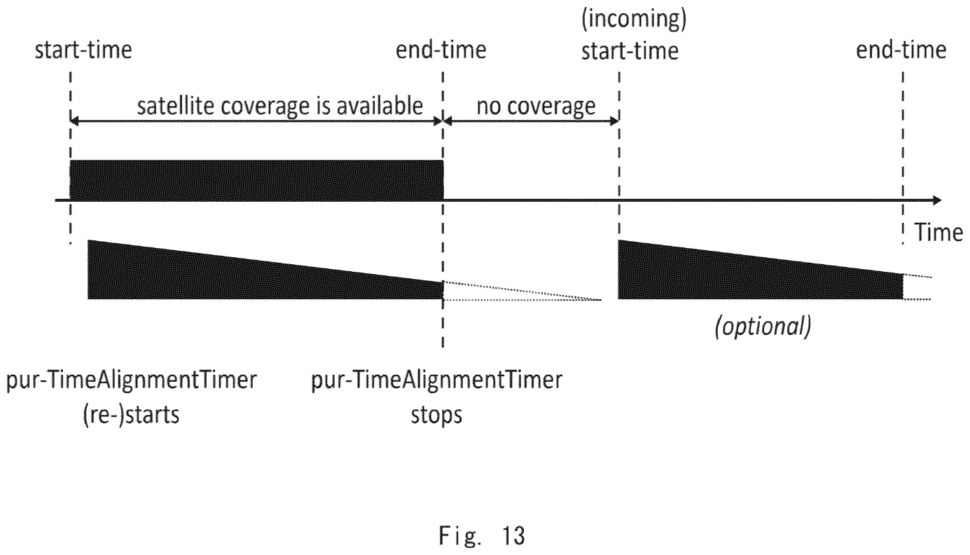

Another approach is illustrated schematically in FIG. 12. In this case, the UE 3 stops or pauses the timing alignment timer (e.g. pur-TimeAlignmentTimer) upon leaving the serving cell and restarts or continues the timer once camping on a new serving cell (different from the PUR configuration cell). In other words, the timer is only running while the UE 3 is in coverage of the non-terrestrial network (satellite coverage is available). FIG. 12 illustrates the scenario in which the UE 3 continues running the timer when it starts camping on a new serving cell. On the other hand, FIG. 13 illustrates the possibility to restart the timer (using its initial value) instead of continuing the timer.

Effectively, the UE 3 may be configured to stop the pur-TimeAlignmentTimer or consider it as having expired upon changing serving cell and it may continue or restart the timer once camping on a new cell. This solution may be configured with any of the other solutions, if appropriate.

The duration of the associated timer in the new serving cell(s) may be configured by the initial PUR configuration (via one or more associated information element) and/or may be provided in the new serving cell (e.g. in system information). Accordingly, different duration for the PUR configuration may be applied in different cells, or different durations may be associated with different cell(s) by indicating the association.

In another approach, the UE 3 ignores the pur-TimeAlignmentTimer in the new serving cell(s). Effectively, the UE 3 may be configured to stop the timer or consider it as having expired upon leaving the cell where the PUR was configured. In this case, the expiration of the timer does not invalidate the PUR. In this case, the UE 3 may be configured to wait until the same cell coverage is available before it continues to apply the PUR configuration. This approach may be beneficial in a case when different UEs (or groups of UEs) are associated to different satellites or cells and in case of transmitting delay tolerant data. It will be appreciated that this approach may be combined with the approach described above with reference to FIG. 12.

FIG. 13 illustrates schematically yet another approach for handling the timer associated with PUR in a non-terrestrial cell. In this case, the UE 3 stops the associated timer (pur-TimeAlignmentTimer) at the end-time of the serving satellite's coverage and renders the PUR configuration invalid. Contrastingly, in a terrestrial cell or any other cell with continuous coverage, the PUR configuration becomes invalid at the expiry of the associated pur-TimeAlignmentTimer. Effectively, in this case the UE 3 controls validity of the timing advance value/PUR configuration based on whether or not the UE 3 is in a non-terrestrial cell (to which the timing advance value/PUR configuration applies).

At the next start-time of the (incoming) satellite's coverage, when the UE 3 starts camping on a new serving cell, the UE's behaviour may be the same as in any of the other approaches described above. For example, the UE 3 may restart the timer (depending on which satellite/non-terrestrial node serves the new serving cell).

In summary, the UE 3 stops the associated PUR timer (pur-TimeAlignmentTimer) when satellite coverage ends or becomes unavailable and (re) starts the PUR timer each time when it starts camping on a new cell (including the initial cell when the UE 3 releases its RRC connection) when satellite coverage becomes available. In other words, the associated timer is not running whilst the UE 3 is out of satellite (NTN cell) coverage. Consequently, the UE 3 does not need to count any PUR occasions (see FIG. 9) while the timer is not running and the UE 3 may be able to enter a power saving or low power mode earlier.

### Modifications and Alternatives

Detailed embodiments have been described above. As those skilled in the art will appreciate, a number of modifications and alternatives can be made to the above embodiments whilst still benefiting from the disclosure embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). The term base station may refer to any of the following nodes defined in 3GPP Technical Specifications 38.300 (V16.8.0) and 37.340 (V16.8.0):

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

TABLE 1
types of satellites and UAS platforms

| | | | Typical |
|---|---|---|---|
| | | | beam |
| | Altitude | | footprint |
| Platforms | range | Orbit | size |
| Low-Earth Orbit | 300-1500 | Circular around the | 100-1000 |
| (LEO) satellite | km | earth | km |
| Medium-Earth Orbit | 7000-25000 | | 100-1000 |
| (MEO) satellite | km | | km |
| Geostationary Earth | 35 786 km | Notional station | 200-3500 |
| Orbit (GEO) satellite | | keeping position fixed | km |
| UAS platform | 8-50 km | in terms of elevation/ | 5-200 |
| (including HAPS) | (20 km for | azimuth with respect | km |
| | HAPS) | to a given earth point | |
| High Elliptical Orbit | 400-50000 | Elliptical around the | 200-3500 |
| (HEO) satellite | km | earth | km |

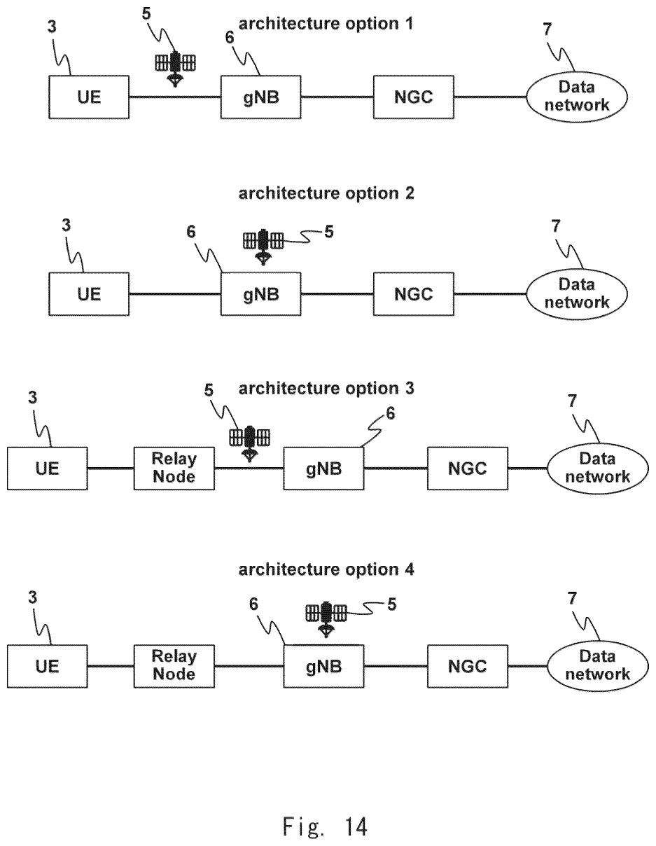

It will be appreciated that there are various architecture options to implement NTN in a 5G/NR system, some of which are illustrated schematically in FIG. 14. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS. It will be appreciated that similar architecture options may be used in a 4G/E-UTRA system as well, but with eNB instead of gNB, and EPC instead of NGC.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment.

The first method performed by the UE may comprise receiving the configuration information in a message for releasing an RRC connection or a message for RRC reconfiguration.

The first method performed by the UE may further comprise transmitting data using the preconfigured uplink resources in a cell that is included in the plurality of cells.

The information identifying the plurality of cells may include, for each cell, at least one of: a physical cell ID (PCI), a Cell Global ID (CGI), and a carrier frequency.

The information identifying the plurality of cells may include a list of cells or an area configuration. The area configuration may be defined or received separately from the configuration information and it may cover more than one cell.

The preconfigured uplink resources may be associated with a predetermined geographical area.

The second method performed by the UE may further comprise transmitting data using the preconfigured uplink resources in the second cell based on the configuration information.

The second method performed by the UE may further comprise determining that the second cell corresponds to the first cell based on an indication received from a base station serving the first cell or a base station serving the second cell.

The indication may indicate that second cell is substantially identical to the first cell. Alternatively, the indication may indicate that the preconfigured uplink resources are applicable for the second cell.

The second method performed by the UE may further comprise receiving the indication via a master information block or a system information block.

The second method performed by the UE may further comprise determining that the second cell corresponds to the first cell based on at least one of: an information element indicating that system information is unchanged; a physical cell identity (PCI), a Cell Global ID (CGI), a carrier frequency, a bandwidth, a system Info Value Tag, a cell identity, a primary synchronization signal (PSS), a secondary synchronization signal (SSS), a master information block (MIB), and a system information block (SIB) associated with the second cell.

The receiving, by the UE, of information relating to the coverage may include receiving at least one of: ephemeris data relating to the at least one non-terrestrial cell; information identifying a coverage start-time associated with the at least one non-terrestrial cell, information identifying a coverage end-time associated with the at least one non-terrestrial cell, a timing advance parameter associated with the at least one non-terrestrial cell.

The third method performed by the UE may further comprise transmitting data using the preconfigured uplink resources based on the configuration information.

The third method performed by the UE may further comprise controlling a wake-sleep operation of the UE based on the information relating to the coverage, such that the UE wakes up and applies the configuration information in a case that the UE is determined to be in coverage.

The third method performed by the UE may further comprise: applying the configuration information in a case that the UE camps on a cell that belongs to the at least one non-terrestrial cell based on the information relating to the coverage; and keeping the configuration information in a case that the UE is out of coverage based on the information relating to the coverage.

The third method performed by the UE may further comprise receiving information identifying at least one non-terrestrial node for which the configuration information is applicable.

The third method performed by the UE may further comprise receiving information identifying a number of occasions that the UE is allowed to miss the preconfigured uplink resources before releasing the configuration information identifying the preconfigured uplink resources, wherein the number of occasions identifies a number of occasions within at least one predetermined period during which the UE is in coverage of the at least one non-terrestrial cell.

The fourth method performed by the UE may further comprise transmitting data using the preconfigured uplink resources based on the information for identifying the area.

The information for identifying the area may include information indicating a beam footprint size. The information for identifying the area may include a threshold for a variation of a position of the UE.

The applying, by the UE, of the configuration information whilst the UE is within the area may include determining a difference between a reference position and a current position of the UE and applying the configuration information when the difference is less than or equal to the threshold. The reference position may be a position of the UE when the UE enters the RRC idle state in response to receiving a message including the configuration information or a position obtained in the RRC idle state after receiving the message including the configuration information.

The controlling the validity of the timing advance value may include ignoring an associated validity timer in a case that the UE is using non-terrestrial services or in a case that the UE is camping on a non-terrestrial cell.

The controlling the validity of the timing advance value may include starting an associated validity timer, and treating the timing advance value as valid upon expiry of the validity timer in a case that the UE is using non-terrestrial services or in a case that the UE is camping on a non-terrestrial cell.

The controlling the validity of the timing advance value may include stopping an associated validity timer upon changing a serving cell from a cell in which the configuration information was received to a different cell.

The controlling the validity of the timing advance value may include restarting the associated validity timer when the UE reselects to camp on a new non-terrestrial cell.

The fifth method performed by the UE may further comprise receiving information identifying a respective value for the associated validity timer for each one of the at least one non-terrestrial cell.

The controlling the validity of the timing advance value may include not applying a validity timer associated with the different cell.

The fifth method performed by the UE may further comprise: receiving information identifying a coverage start-time associated with at least one non-terrestrial node serving the at least one non-terrestrial cell; and starting the validity timer at the coverage start-time causing the timing advance value to become valid in the at least one non-terrestrial cell.

The fifth method performed by the UE may further comprise: receiving information identifying a coverage end-time associated with the at least one non-terrestrial node serving the at least one non-terrestrial cell; and stopping the associated validity timer at the coverage end-time causing the timing advance value to become invalid in the at least one non-terrestrial cell.

Various other modifications will be apparent to those skilled in the art and will not be described in further detail here.

### LIST OF REFERENCES

[1] 3GPP Technical Report (TR) 36.763 V17.0.0
[2] 3GPP TR 38.811 V15.4.0
[3] 3GPP TR 38.821 V16.1.0
[4] 3GPP TR 36.763
[5] 3GPP Technical Specifications (TS) 36.331,
[6] 3GPP TS 38.300 V16.8.0
[7] 3GPP TS 37.340 V16.8.0

Although the present disclosure has been described with reference to the exemplary embodiments, the present disclosure is not limited to the above. Various changes that can be understood by those skilled in the art can be made to the configuration and details of the present disclosure within the scope of the disclosure.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

For example, the whole or part of the exemplary embodiments disclosed above can be described as, but not limited to, the following supplementary notes.

### Supplementary Note 1

A method performed by a user equipment (UE) for communicating via a non-terrestrial network, the method comprising:
receiving configuration information identifying preconfigured uplink resources for use by the UE in a Radio Resource Control (RRC) idle state;
verifying whether or not the configuration information is still valid; and
determining whether to transmit data using the preconfigured uplink resources in accordance with the verifying.

### Supplementary Note 2

The method according to supplementary note 1, further comprising:
receiving information indicating whether the configuration information is valid, and wherein
the verifying is performed using the information.

### Supplementary Note 3

The method according to supplementary note 2, wherein
the information includes cell information identifying a plurality of cells where the configuration information is valid, and wherein
the verifying is performed by using the cell information.

### Supplementary Note 4

The method according to supplementary note 2, wherein
the information includes cell information identifying a plurality of cells which are identical or replacement to a first cell which corresponds to the configuration information, and
the verifying is performed by using the cell information in a case where the UE is out of coverage of the first cell and in coverage of a second cell included in the plurality of cells indicated by the cell information.

### Supplementary Note 5

The method according to supplementary note 3 or 4, wherein the cell information includes, for each cell, at least one of:
a physical cell ID (PCI),
a Cell Global ID (CGI), and
a carrier frequency.

### Supplementary Note 6

The method according to any one of supplementary notes 3 to 5, wherein the cell information includes a list of cells or an area configuration.

### Supplementary Note 7

The method according to supplementary note 6, wherein the area configuration is defined or received separately from the configuration information and covers more than one cell.

### Supplementary Note 8

The method according to supplementary note 4, further comprising
determining that the second cell corresponds to the first cell based on at least one of:
an information element indicating that system information is unchanged;
a physical cell identity (PCI),
a Cell Global ID (CGI),
a carrier frequency,
a bandwidth,
a system Info Value Tag,
a cell identity,
a primary synchronization signal (PSS),
a secondary synchronization signal (SSS),
a master information block (MIB), and
a system information block (SIB) associated with the second cell.

### Supplementary Note 9

The method according to supplementary note 2, wherein
the information includes coverage information relating to a coverage provided via at least one non-terrestrial cell operated by the non-terrestrial network, and wherein
the verifying is performed by using the coverage information.

### Supplementary Note 10

The method according to supplementary note 9, wherein coverage information includes at least one of:
ephemeris data relating to the at least one non-terrestrial cell;
information identifying a coverage start-time associated with the at least one non-terrestrial cell;
information identifying a coverage end-time associated with the at least one non-terrestrial cell; and
a timing advance parameter associated with the at least one non-terrestrial cell.

### Supplementary Note 11

The method according to supplementary note 9 or 10, further comprising:
controlling a wake-sleep operation of the UE based on the information relating to the coverage, such that the UE wakes up and applies the configuration information in a case that the UE is determined to be in coverage.

### Supplementary Note 12

The method according to any one of supplementary notes 9 to 11, further comprising:
applying the configuration information in a case that the UE camps on a cell that belongs to the at least one non-terrestrial cell based on the coverage information; and
keeping the configuration information in a case that the UE is out of coverage based on the coverage information.

### Supplementary Note 13

The method according to any one of supplementary notes 9 to 12, further comprising:
receiving information identifying at least one non-terrestrial node for which the configuration information is applicable.

### Supplementary Note 14

The method according to any one of supplementary notes 9 to 13, further comprising:
receiving information identifying a number of occasions that the UE is allowed to miss the preconfigured uplink resources before releasing the configuration information,
wherein the number of occasions identifies a number of occasions within at least one predetermined period during which the UE is in coverage of the at least one non-terrestrial cell.

### Supplementary Note 15

The method according to supplementary note 2, wherein
the information includes location information for identifying an area where the configuration information is valid, and wherein
the verifying is performed by using the location information.

### Supplementary Note 16

The method according to supplementary note 15, wherein the location information indicates a predetermined geographical area.

### Supplementary Note 17

The method according to supplementary note 15 or 16, wherein the location information includes information indicating a beam footprint size.

### Supplementary Note 18

The method according to any one of supplementary notes 15 to 17, wherein the location information includes a threshold for a variation of a position of the UE.

### Supplementary Note 19

The method according to supplementary note 18, further comprising:
determining a difference between a reference position and a current position of the UE, and wherein
the verifying that the configuration information is valid in a case where the difference is less than or equal to the threshold.

### Supplementary Note 20

The method according to supplementary note 19, wherein the reference position is a position of the UE in a case where the UE enters the RRC idle state in response to receiving a message including the configuration information or a position obtained in the RRC idle state after receiving the message including the configuration information.

### Supplementary Note 21

The method according to supplementary note 2, wherein
the information includes control information for controlling a timer for transmission using the preconfigured uplink resources, and wherein
the verifying is performed by using the timer controlled by the control information.

### Supplementary Note 22

The method according to supplementary note 21, further comprising:
controlling a validity of a timing advance value corresponding to the timer, based on whether the UE is in at least one non-terrestrial cell operated by the non-terrestrial network, and wherein
the verifying is performed based on the controlling the validity of the timing advance value.

### Supplementary Note 23

The method according to supplementary note 22, wherein the controlling the validity of the timing advance value includes ignoring the timer in a case that the UE is using non-terrestrial services or in a case that the UE is camping on one of the at least one non-terrestrial cell.

### Supplementary Note 24

The method according to supplementary note 22, wherein the controlling the validity of the timing advance value includes:
starting the timer, and
treating the timing advance value as valid upon expiry of the timer in a case that the UE is using non-terrestrial services or in a case that the UE is camping on one of the at least one non-terrestrial cell.

### Supplementary Note 25

The method according to supplementary note 22, wherein the controlling the validity of the timing advance value includes stopping the timer upon changing a serving cell from a cell in which the configuration information was received to a different cell.

### Supplementary Note 26

The method according to supplementary note 22 or 25, wherein the controlling the validity of the timing advance value includes restarting the timer in a case where the UE reselects to camp on a new non-terrestrial cell.

### Supplementary Note 27

The method according to any one of supplementary notes 23 to 26, further comprising receiving information identifying a respective value for the timer for each one of the at least one non-terrestrial cell.

### Supplementary Note 28

The method according to supplementary note 25, wherein the controlling the validity of the timing advance value includes not applying a timer associated with the different cell.

### Supplementary Note 29

The method according to any one of supplementary notes 22 to 28, further comprising:
receiving information identifying a coverage start-time associated with at least one non-terrestrial node serving the at least one non-terrestrial cell; and
starting the timer at the coverage start-time causing the timing advance value to become valid in the at least one non-terrestrial cell.

### Supplementary Note 30

The method according to any one of supplementary notes 22 to 29, further comprising:
receiving information identifying a coverage end-time associated with the at least one non-terrestrial node serving the at least one non-terrestrial cell; and
stopping the timer at the coverage end-time causing the timing advance value to become invalid in the at least one non-terrestrial cell.

### Supplementary Note 31

The method according to any one of supplementary notes 1 to 30, wherein the configuration information is included in a message for releasing an RRC connection or a message for RRC reconfiguration.

### Supplementary Note 32

The method according to any one of supplementary notes 1 to 30, the information indicating whether the configuration information is valid is transmitted via a master information block or a system information block.

### Supplementary Note 33

A method performed by an access network node for communicating with a user equipment (UE) via a non-terrestrial network, the method comprising:
transmitting configuration information identifying preconfigured uplink resources for use by the UE in a Radio Resource Control (RRC) idle state; and
transmitting receiving information indicating whether the configuration information is valid, and wherein
the information is used by the UE for verifying whether or not the configuration information is still valid.

### Supplementary Note 34

A user equipment (UE) for communicating via a non-terrestrial network, the UE comprising:
means for receiving configuration information identifying preconfigured uplink resources for use by the UE in a Radio Resource Control (RRC) idle state;
means for verifying whether or not the configuration information is still valid; and
means for determining whether to transmit data using the preconfigured uplink resources in accordance with the verifying.

### Supplementary Note 35

An access network node for communicating with a user equipment (UE) via a non-terrestrial network, the access network node comprising:
means for transmitting configuration information identifying preconfigured uplink resources for use by the UE in a Radio Resource Control (RRC) idle state; and
means for transmitting receiving information indicating whether the configuration information is valid, and wherein
the information is used by the UE for verifying whether or not the configuration information is still valid.

This application is based upon and claims the benefit of priority from United Kingdom patent application No. 2203837.6, filed on Mar. 18, 2022, the disclosure of which is incorporated herein in its entirety by reference.

### REFERENCE SIGNS LIST

1 telecommunication system
3 mobile device
5 NTN node
6 base station
7 data network

What is claimed is:

1. A method performed by a user equipment (UE) for communicating via a non-terrestrial network, the method comprising:
receiving, on a first cell, configuration information identifying preconfigured uplink resources for use by the UE in a Radio Resource Control (RRC) idle state;
reselecting a cell which the UE camps on to a second cell;
verifying whether or not the configuration information is still valid on the second cell in response to the reselecting the cell; and
determining whether to transmit data using the preconfigured uplink resources in accordance with the verifying.

2. The method according to claim 1, further comprising:
receiving information indicating whether the configuration information is valid, and wherein
the verifying is performed using the information.

3. The method according to claim 2, wherein
the information includes cell information identifying a plurality of cells where the configuration information is valid, and wherein
the verifying is performed by using the cell information.

4. The method according to claim 2, wherein
the information includes cell information identifying a plurality of cells which are identical or replacement to a first cell which corresponds to the configuration information, and
the verifying is performed by using the cell information in a case where the UE is out of coverage of the first cell and in coverage of a second cell included in the plurality of cells indicated by the cell information.

5.-8. (canceled)

9. The method according to claim 2, wherein
the information includes coverage information relating to a coverage provided via at least one non-terrestrial cell operated by the non-terrestrial network, and wherein
the verifying is performed by using the coverage information.

10. The method according to claim 9, wherein the coverage information includes at least one of:
ephemeris data relating to the at least one non-terrestrial cell;
information identifying a coverage start-time associated with the at least one non-terrestrial cell;
information identifying a coverage end-time associated with the at least one non-terrestrial cell; and
a timing advance parameter associated with the at least one non-terrestrial cell.

11. The method according to claim 9, further comprising:
controlling a wake-sleep operation of the UE based on the information relating to the coverage, such that the UE wakes up and applies the configuration information in a case that the UE is determined to be in coverage.

12. The method according to claim 9, further comprising:
applying the configuration information in a case that the UE camps on a cell that belongs to the at least one non-terrestrial cell based on the coverage information; and
keeping the configuration information in a case that the UE is out of coverage based on the coverage information.

13. The method according to claim 9, further comprising:
receiving information identifying at least one non-terrestrial node for which the configuration information is applicable.

14. The method according to claim 9, further comprising:
receiving information identifying a number of occasions that the UE is allowed to miss the preconfigured uplink resources before releasing the configuration information,
wherein the number of occasions identifies a number of occasions within at least one predetermined period during which the UE is in coverage of the at least one non-terrestrial cell.

15. The method according to claim 2, wherein
the information includes location information for identifying an area where the configuration information is valid, and wherein
the verifying is performed by using the location information.

16.-20. (canceled)

21. The method according to claim 2, wherein
the information includes control information for controlling a timer for transmission using the preconfigured uplink resources, and wherein
the verifying is performed by using the timer controlled by the control information.

22. The method according to claim 21, further comprising:
controlling a validity of a timing advance value corresponding to the timer, based on whether the UE is in coverage of at least one non-terrestrial cell operated by the non-terrestrial network, and wherein
the verifying is performed based on the controlling the validity of the timing advance value.

23. The method according to claim 22, wherein the controlling the validity of the timing advance value includes ignoring the timer in a case that the UE is using non-terrestrial services or in a case that the UE is camping on one of the at least one non-terrestrial cell.

24. The method according to claim 22, wherein the controlling the validity of the timing advance value includes:
starting the timer, and
treating the timing advance value as valid upon expiry of the timer in a case that the UE is using non-terrestrial services or in a case that the UE is camping on one of the at least one non-terrestrial cell.

25. The method according to claim 22, wherein the controlling the validity of the timing advance value includes stopping the timer upon changing a serving cell from a cell in which the configuration information was received to a different cell.

26.-27. (canceled)

28. The method according to claim 25, wherein the controlling the validity of the timing advance value includes not applying a timer associated with the different cell.

29.-32. (canceled)

33. A method performed by an access network node for communicating with a user equipment (UE) via a non-terrestrial network, the method comprising:
transmitting, on a first cell, configuration information identifying preconfigured uplink resources for use by the UE in a Radio Resource Control (RRC) idle state; and
transmitting information indicating whether the configuration information is valid, and wherein
the information is used by the UE which reselect a cell which the UE camps on to a second cell for verifying whether or not the configuration information is still valid on the second cell.

34. A user equipment (UE) for communicating via a non-terrestrial network, the UE comprising:
means for receiving, on a first cell, configuration information identifying preconfigured uplink resources for use by the UE in a Radio Resource Control (RRC) idle state;
means for reselecting a cell which the UE camps on to a second cell;
means for verifying whether or not the configuration information is still valid on the second cell in response to the reselecting the cell; and
means for determining whether to transmit data using the preconfigured uplink resources in accordance with the verifying.

35. An access network node for communicating with a user equipment (UE) via a non-terrestrial network, the access network node comprising:
means for transmitting, on a first cell, configuration information identifying preconfigured uplink resources for use by the UE in a Radio Resource Control (RRC) idle state; and
means for transmitting information indicating whether the configuration information is valid, and wherein
the information is used by the UE which reselect a cell which the UE camps on to a second cell for verifying whether or not the configuration information is still valid on the second cell.
